(19) United States
(12) Patent Application Publication
(10) Pub. No.: US 2007/0210697 A1
(43) Pub. Date: Sep. 13, 2007

(54) IMAGE DISPLAY DEVICE

(76) Inventors: Takuo Tamura, Yokohama (JP); Yasushi Sano, Yokohama (JP); Kazushi Miyata, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/679,968

(22) Filed: Feb. 28, 2007

(30) Foreign Application Priority Data
Mar. 10, 2006 (JP) 2006-065108

(51) Int. Cl. H01J 1/62

(52) U.S. Cl. 313/496

(57) ABSTRACT

Disclosed herein is an image display device including: plural pixels arranged two-dimensionally; and a thin film electron emitter that has a lower electrode formed of one of data lines, an electron acceleration layer formed by an anodic oxidation of a surface of the lower electrode, and an upper electrode stacked on the electron acceleration layer to emit electrons thereby provided in each of the plural pixels, in which a ratio of hydrate-alumina to the total of the hydrate-alumina and anhydrous-alumina contained in the electron acceleration layer (the anodic oxide film) arranged in each of the pixels in regulated in a range from 0.25 to 0.42.

### CROSS REFERENCES TO RELATED APPLICATIONS

The present application claims priority from Japanese application JP2006-065108 filed on Mar. 10, 2006, the content of which is hereby incorporated by reference into this application.

### BACKGROUND OF THE INVENTION

1. Field of the Invention

The present invention concerns an image display device which is, particularly, suitable to a light-emitting image display device also referred to as a flat panel display using an electron emitter array.

2. Description of the Related Art

A thin film electron emitter basically has a structure of stacking three types of thin films of an upper electrode, an electron acceleration layer, and a lower electrode. The thin film electron emitter emits electrons from the surface of the upper electrode into vacuum by applying a voltage between the upper electrode and the lower electrode.

A thin film electron emitter includes an MIM type (formed by stacking a Metal, an Insulator, and a Metal); an MIS type (formed by stacking a Metal, an Insulator, and a Semiconductor), and an MISM type (formed by stacking a Metal, an Insulator, a Semiconductor, and a Metal).

The MIM type is disclosed in Patent Document 1, Patent Document 2, and Patent Document 3. As for the MIS type, an MOS type is disclosed in Non-Patent Document 1. As for the MISM type, a HEED type is disclosed in Non-Patent Document 2, an EL type in Non-Patent Document 3, and a porous silicon type in Non-Patent Document 4.

Patent documents and Non-patent documents each referred above or later are listed as follows.
[Patent Document 1] Japanese Patent Laid-Open Publication (refer to as JP-A, hereinafter) No. 1995-65710 (JP 07065710 A).
[Non-Patent Document 1] K. Yakoo, et al, “Emission characteristics of metal-oxide-semiconductor electron tunneling cathode”, J. Vac. Sci. Technol. B11(2) pages 429-432 (1993).
[Non-Patent document 2] N. Negishi, et al, “High Efficiency Electron-Emission in Pt/SiOₓ/Si/Al Structure”, Jpn. J. Appl. Phys. Vol. 36, Part 2, No. 7B, pages L939-L941 (1997).
[Non-Patent Document 3] S. Okamoto, “Electron emission from electroluminescent thin film—thin film cold cathode—” (in Japanese), OYO BUTURI, vol. 63, No. 6, pages 592-595 (1994).
[Non-Patent Document 4] N. Koshida, “Light emission from porous silicon—Beyond the indirect/direct transition regime—(in Japanese), OYO BUTURI, vol. 66, No. 5, pages 437-443 (1997).

### SUMMARY OF THE INVENTION

An image display device can be constituted by arranging such electron emitters in plural rows (for example, in the horizontal direction) and plural columns (for example, in the vertical direction) to form a matrix and arranging a number of phosphors being corresponded to each of the electron emitters in vacuum. In the MIM type electron emitter, a film formed by an anodic oxidation method of treating aluminum constituting a lower electrode as data lines in an electrolyte is used as a thin film used for the electron acceleration layer (anodic oxide film: AO film) . In the anodic oxide film, a water content (moisture) is inevitably . . . or necessarily in-taken from the electrolyte. The water content in the anodic oxide film causes degradation of diode characteristics of the MIM type electron emitter. Since the degradation of the diode characteristics lowers the long time reliability of the image display device, it is demanded for properly controlling the water content in the anodic oxide film.

The present invention intends to suppress the degradation of the diode characteristic of the anodic oxide film that constitutes the thin film electron emitter thereby providing a highly reliable image display device.

For attaining the foregoing purpose, the invention provides an image display device of attaining a high reliability by properly controlling the water content in the anodic oxide film that constitutes the electron acceleration layer of the thin film electron emitter typically represented by the MIM type electron emitter.

### BRIEF DESCRIPTION OF THE DRAWINGS

FIG. 1 is a schematic view for explaining example 1 of an image display device according to the invention;

FIG. 2 is an explanatory view for the principle of an MIM type electron emitter;

FIG. 3 is a view showing manufacturing steps of a thin film electron emitter of the invention;

FIG. 4 is a view succeeding to FIG. 3 showing manufacturing steps of the thin film electron emitter of the invention;

FIG. 5 is a view succeeding to FIG. 4 showing manufacturing steps of the thin film electron emitter of the invention;

FIG. 6 is a view succeeding to FIG. 5 showing manufacturing steps of the thin film electron emitter of the invention;

FIG. 7 is a view succeeding to FIG. 6 showing manufacturing steps of the thin film electron emitter of the invention;

FIG. 8 is a view succeeding to FIG. 7 showing manufacturing steps of the thin film electron emitter of the invention;

FIG. 9 is a view succeeding to FIG. 8 showing manufacturing steps of the thin film electron emitter of the invention;

FIG. 10 is a view succeeding to FIG. 9 showing manufacturing steps of the thin film electron emitter of the invention;

FIG. 11 is a view succeeding to FIG. 10 showing manufacturing steps of the thin film electron emitter of the invention;

FIG. 12 is a view for explaining the manufacturing method of a front substrate;

FIG. 13 is a view for the cross-section along the line A-A′ and the cross-section along the line B-B′ in a state of bonding a back substrate to the front substrate;

FIG. 14 is a view for explaining manufacturing steps of the image display device of the invention;

FIG. 15 is a view explaining the temperature dependence of the desorption amount of moisture in the anodic oxide film (the dehydration amount of the anodic oxide film) manufactured in the Example of the invention by conducting thermal desorption analysis for the anodic oxide film;

FIG. 16 is a view for explaining an example of a result of conducting XPS analysis for the quantification of the water content contained in the anodic oxide film of aluminum;

FIG. 17 is a view for explaining the result of calculation for the hydrate-alumina ratio in the alumina film determined by evaluation according to the analysis of FIG. 16 on every annealing process;

FIG. 18 is a view showing the result of measuring the degraded characteristic to the time of the manufactured MIM diode on every annealing process conditions; and

FIG. 19 is a view showing a correlation between the availability ratio of diodes estimated based on the result of FIG. 18 and the hydrate-alumina ratio in an alumina film calculated based on the result of FIG. 17.

### DETAILED DESCRIPTION

The present invention is to be described for a preferred embodiment specifically with reference to the drawings for the examples. Description is to be made for an image display device using an MIM type electron emitter as an example. However, the invention is not restricted to the MIM type electron emitter but it can be applied in the same manner also to an image display device using a thin film electron emitter having an anodic oxide film. Particularly, it is effective also to a hot electron type or surface conduction type electron emitter using a thin electron emission electrode and emitting only a portion of a device current into vacuum.

### Embodiment 1

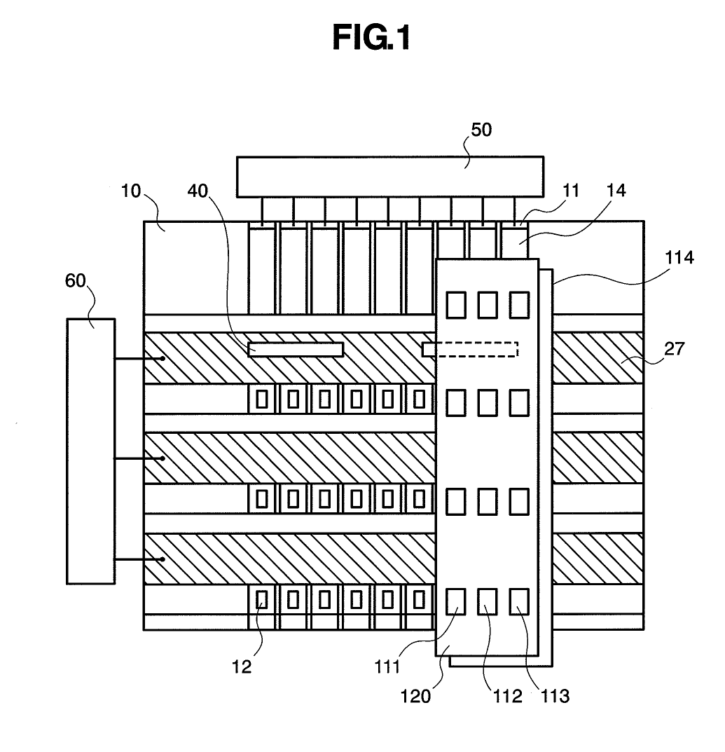

FIG. 1 is a schematic view for explaining Embodiment 1 of an image display device according to the present invention. FIG. 1 shows a plane of one substrate (also referred to as a cathode substrate or a back substrate) 10 having an electron emitter suitably including glass. For the other substrate (also referred to as a phosphor substrate, a display substrate, a front substrate, or a color filter substrate) in which phosphors are formed to a portion thereof and also suitably including a glass, only a black matrix 120 and phosphors 111, 112, and 113 of three colors (red:R, green:G, blue:B) present at the inner surface thereof are shown partially.

In the back substrate 10, are formed lower electrodes 11 that constitute data lines to be connected with a data line driver circuit 50, scan lines 27 disposed crossing (crossing in perpendicular) to the data lines being connected with the scan line driver circuit 60 and other functional films to be described later. A cathode (thin film electron emitter, electron emitter) is formed of an upper electrode 13 (not illustrated in FIG. 1 and described later) disposed within the width of the scan line and stacked by way of a first insulating protection layer (so-called field insulator) 14 to the lower electrode 11, and electrons are emitted from the portion of an electron acceleration layer (also referred to as a tunnel insulator) 12 formed of a thin layer portion of the first insulating protection layer 14 through the upper electrode 13.

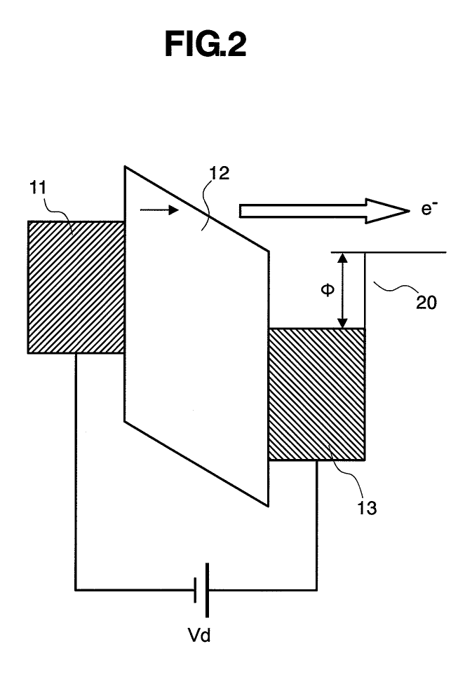

FIG. 2 is an explanatory view for the principle of the MIM type electron emitter. The operation of the MIM electron emitter is described below. That is, it has a structure in which the electron acceleration layer (tunnel insulator) 12 is interposed between the upper electrode 13 and the lower electrode 11, when a driving voltage Vd is applied between the upper electrode 13 and the lower electrode 11 to make the electric field in the tunnel insulator 12 to about 1 to 10 MV/cm, electrons near the Fermi level in the lower electrode 11 transmits a barrier by a tunnel effect, is injected to a conduction band of the tunnel insulator 12 as an electron acceleration layer to be hot electrons and then flow into the conduction band of the upper electrode 13. Among the hot electrons, those reaching the surface of the upper electrode 13 with energy of higher than the work function φ of the upper electrode 13 are emitted in vacuum. As the MIM type electron emitter, an Au—Al₂O₃—Al structure has been known typically. The upper electrode 13 as a so-called electron emission surface is formed as a single layer noble metal such as Au (gold), Pt (platinum), Ag (silver), etc. or as a stacked structure containing two or more noble metal layers. On the other hand, while the lower electrode 11 is formed as a layer of Al (aluminum) or an alloy containing the same, it may also be formed with a layer of a metal material capable of forming an oxide film such as Al₂O₃ (alumina) on the surface thereof (for example, Ta (tantalum) or alloy containing the same).

A light shielding layer for enhancing the contrast of display images, that is, a black matrix 120, and red (R) phosphors 111, green (G) phosphor 112 and blue (B) phosphor 113 are formed to the inner surface of the front substrate not illustrated. As the phosphor, there can be used, for example, Y₂O₂S:Eu (p 22-R) for red, ZnS: Cu or Al (p22-g) for green and ZnS:Ag, Cl(p 22-B) for blue can be used. The back substrate 10 and the display substrate are set at a predetermined distance with a spacer 30 and a sealing frame (not illustrated) is interposed to the outer periphery of a display region to seal the inside under vacuum.

The spacer 40 is placed on the side opposite to the extending direction of the data lines 11 (upper side in FIG. 1) relative to the electron emission portion placed on one side in the lateral direction (lower side FIG. 1) of the scan lines 27 of the back substrate 10 and placed being hidden under the black matrix 120 of the front substrate. The data lines, that is, the lower electrodes 11 are connected to the data line driver circuit 50, and the scan electrode 27 as the scan electrode line are connected with a scan line driver circuit 60. Since a thin upper electrode is used for the array of the thin film electron emitter, an upper bus electrode as a feed line is disposed for application to the image display device.

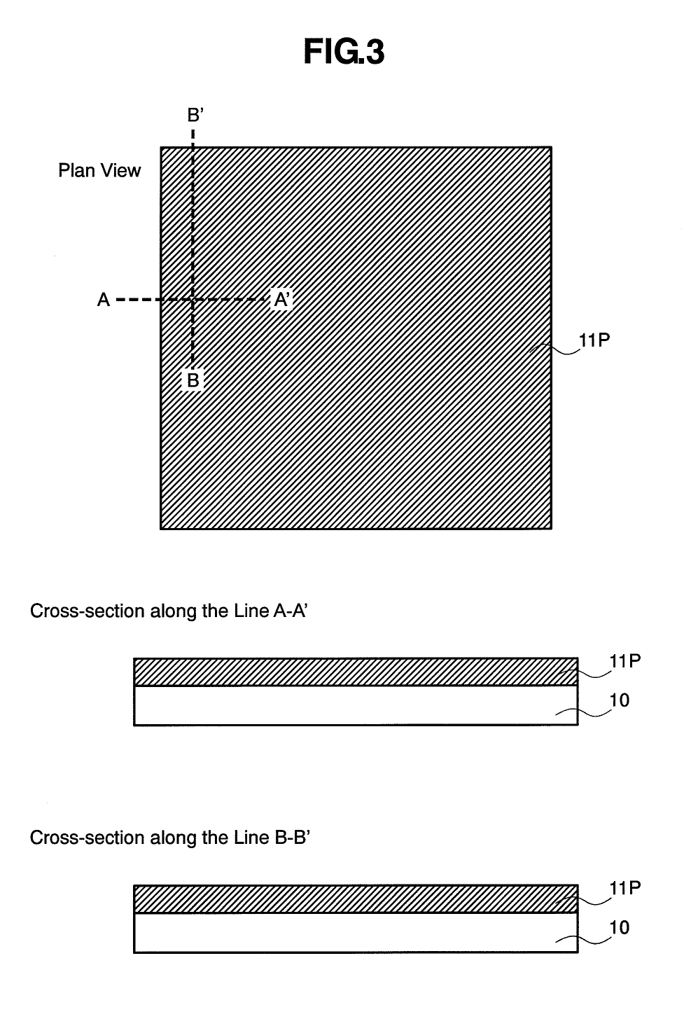

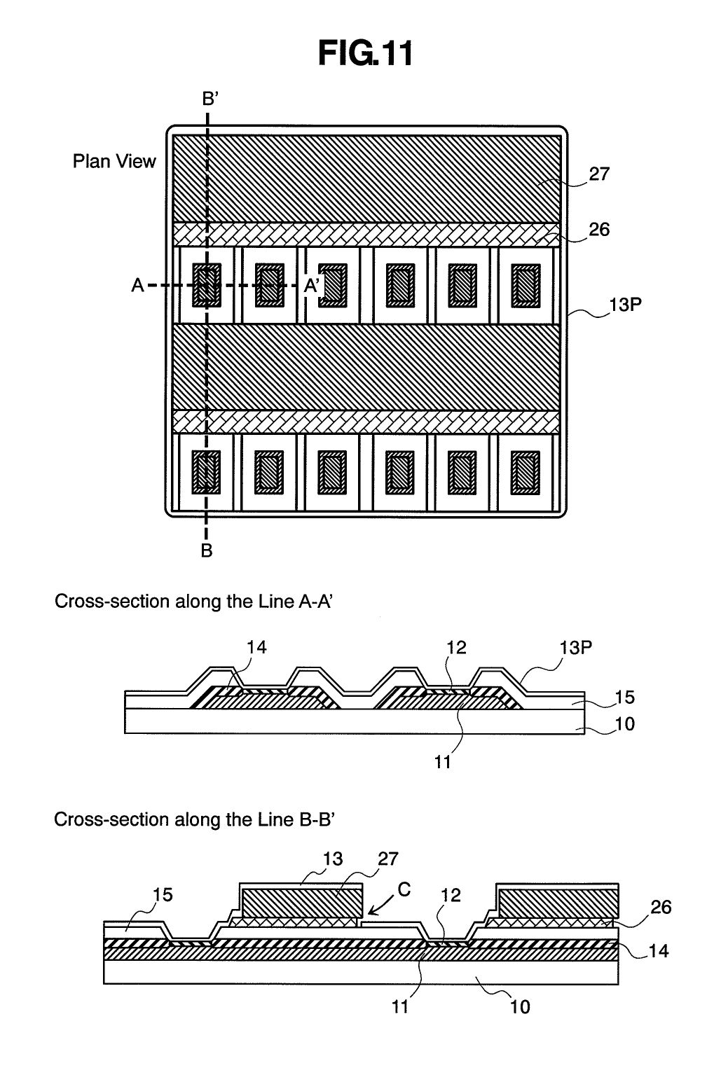

Then, details for the back substrate constituting the image display device of the invention are to be described with reference to the manufacturing process of FIG. 3 to FIG. 11. FIG. 3 to FIG. 11 each shows a plan view of a full color 1 pixel (constituted with red, green, blue sub-pixels) and a cross-sections along lines A-A′ and B-B′ of the plan view. At first, as shown in FIG. 3, a metal film lip for use in the lower electrode (data line) 11 is formed on an insulating back substrate 10 such as formed of glass. As the material for the metal film lip, aluminum (Al) or aluminum alloy (for example, alloy of aluminum and neodymium Nd: Al—Nd) is used. Al is used because an insulation film of good quality can be formed by an anodic oxidation. In this case, an Al—Nd alloy doped with 2 at % of Nd is used. For film formation deposition, a sputtering method is used for the instance. The film thickness is 300 nm.

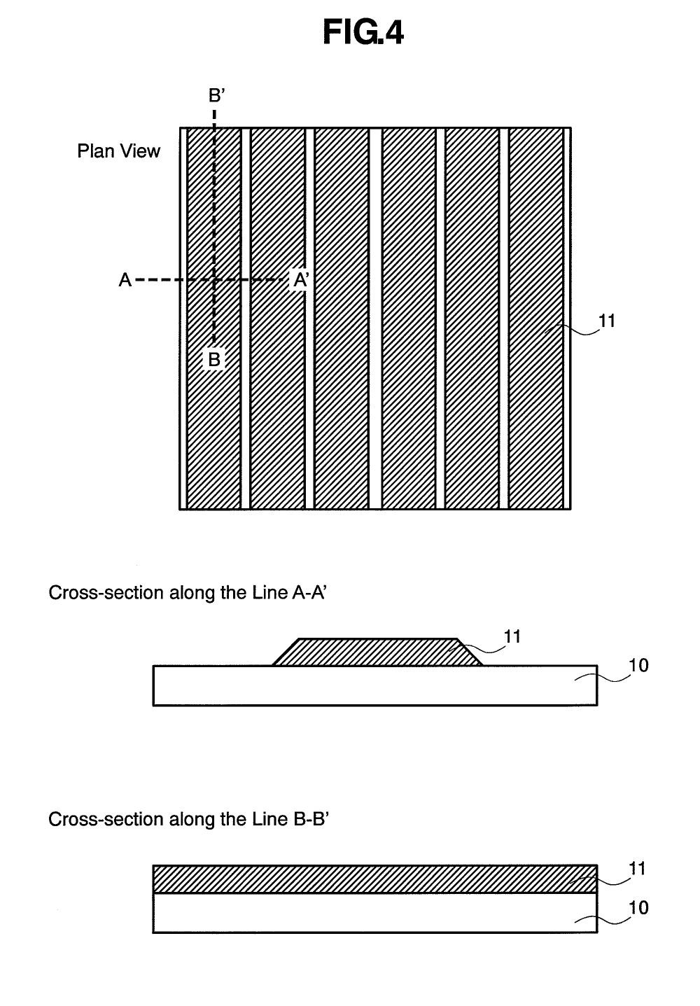

After the deposition of the metal film lip, stripe-like lower electrodes 11 are formed by a patterning step and an etching step (FIG. 4). While the electrode width of the lower electrode 11 is different depending on the size and the resolution power of the image display device, it is about at a pitch of sub-pixel, that is, approximately from 100 to 200 micron (μm). For etching, wet etching with an aqueous mixed solution of phosphoric acid, acetic acid, and nitric acid is used for example. Since the electrode has a wide and simple stripe structure, patterning for etching resist can be applied by inexpensive proximity exposure or printing method.

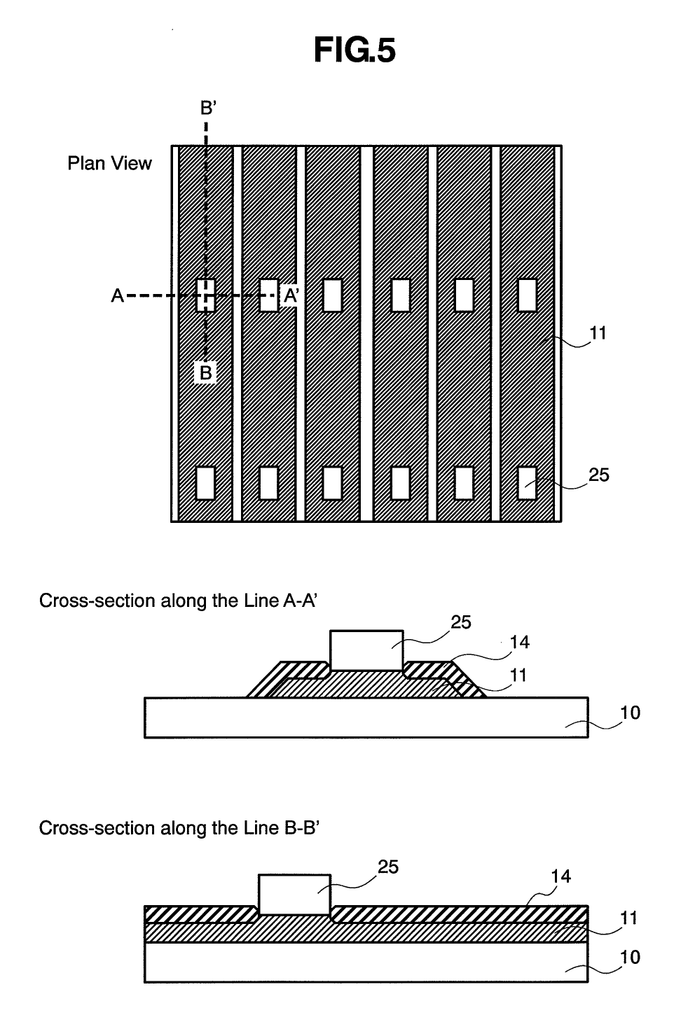

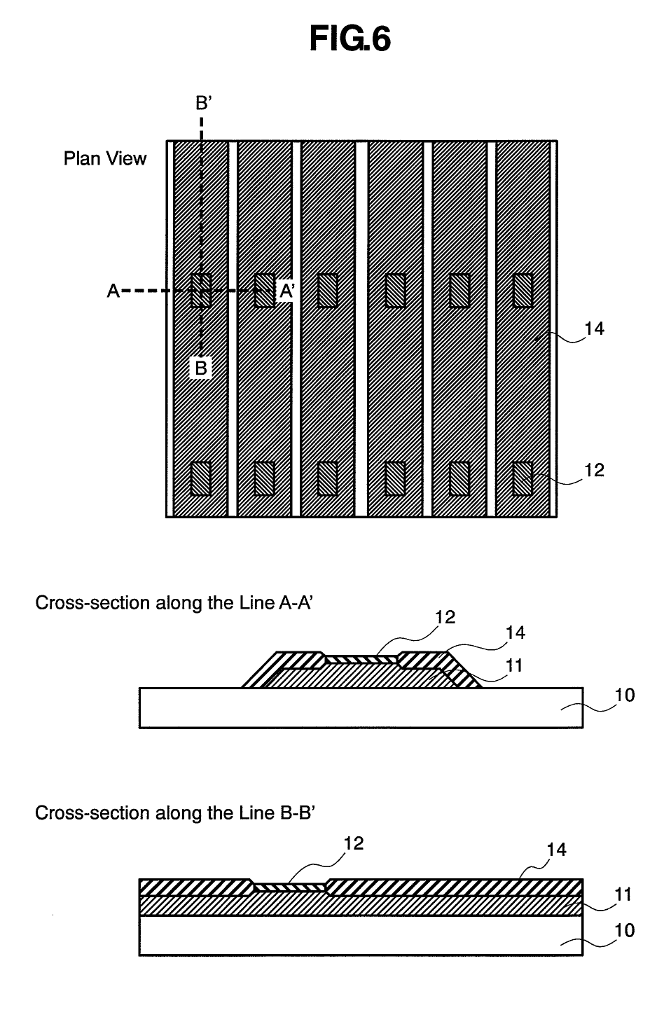

Then, the first insulating protection layer 14 and a tunnel insulator 12 are formed for restricting the electron emission portion and preventing the electric field from concentration to the edge of the lower electrode 11. At first, a portion on the lower electrode 11 as an electron emission portion shown in FIG. 5 is masked with an etching resist film 25 and other portions are applied with anodic oxidation (anodic treatment) selectively thickly to form the insulating protection layer 14. When the anodic voltage is set to 100V, the first insulating protection layer 14 at a thickness of about 136 nm is formed. Then, the etching resist film 25 is removed and the surface of the remaining lower electrode 11 is anodized (to have an oxide layer formed thereon by anodic oxidization thereof). For example, when the anodic voltage is set to 6V, the tunnel insulator (electron acceleration layer) 12 of about 10 nm in thickness is formed above the lower electrode 11 (FIG. 6).

Then, for desorption of the water content taken from the electrolyte during anodic treatment (dehydration of the tunnel insulator 12), a heat treatment is applied to the tunnel insulator 12. In this embodiment, a heat treatment (annealing treatment) for the tunnel insulator 12 is conducted in each of the atmosphere in atmospheric air, in vacuum and nitrogen respectively.

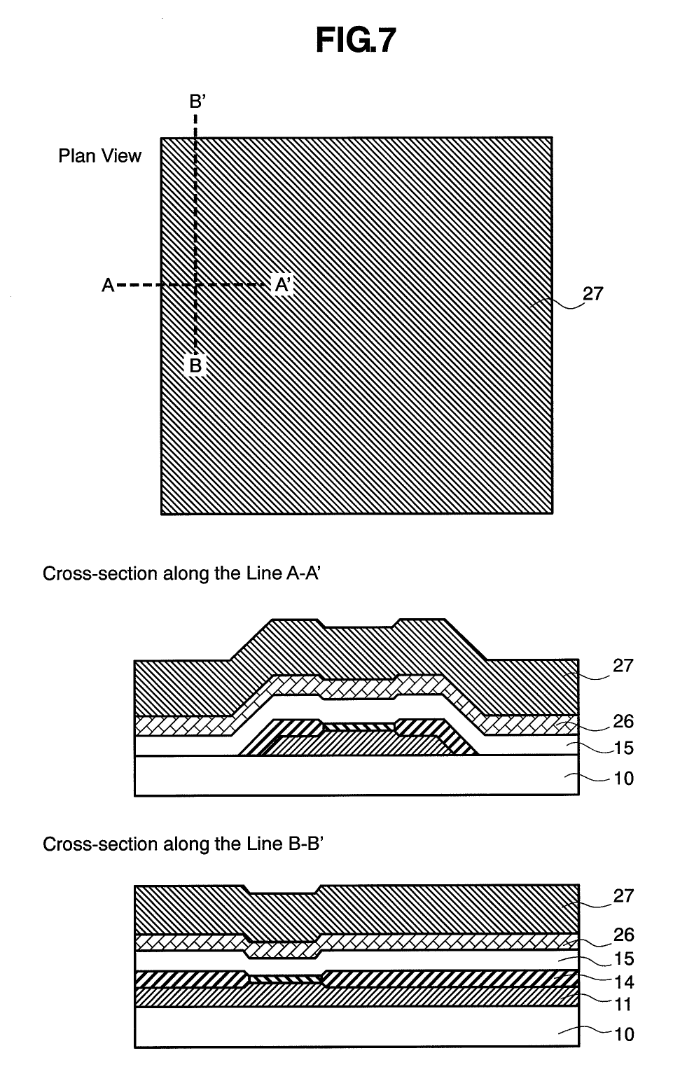

Then, an upper bus electrode film (scan lines) as a power feed line to the upper electrode 13 is formed as a stacked structure in which first metal layer 26 and a second metal layer 27 are stacked. The planer shape of the power feed line (scan line) is described above for the scan electrode line appended, for example, with a reference number 27 but the cross-sectional shape thereof is not restricted to the single layer of a conductive material but may also be in a stacked structure containing at least two layers thereof. In this embodiment, an interlayer insulation film (second insulating protection layer) 15 as an underling film for the power feed line (upper bus electrode), the first metal layer (the upper bus electrode in a narrow meaning) 26, and a second metal film 27 are formed in this order for example by a sputtering method above the main surface of the insulating substrate (back substrate) 10 formed with the data line (including lower electrode) 11 and the tunnel insulator (including a region as an electron acceleration layer) 12 (see FIG. 7). The interlayer insulating film 15 is formed to a film thickness of 100 nm using, for example, a silicon nitride film. The interlayer insulating film 15 serves to fill defects of pinholes, if any, in the first insulating protection layer 14 formed by an anodic oxidation of the data lines (including lower electrode) 11 and maintain electrical insulation between the lower electrode 11 and the upper bus electrode 26.

In this embodiment, chromium (Cr) is used as the material for the first metal layer (upper bus electrode) 26, and an aluminum-neodymium (Al—Nd) alloy is used as the material of the second metal film 27, respectively. In addition to chromium (Cr), molybdenum (Mo), tungsten (W), titanium (Ti), niobium (Nb), etc., can be used as the material for the first metal layer (upper bus electrode) 26, and aluminum (Al, for example, pure aluminum), copper (Cu), chromium, chromium alloy, etc. can be used in addition to the aluminum-neodymium (Al—Nd) alloy as the material of the second metal layer 17. The thickness of the first metal layer (upper bus electrode) 26 is 50 nm, and the second metal film 27 is formed to a thickness more than that of the first metal layer and the film thickness is, for example, several micron meters. The aluminum alloy as the material of the second metal film 27 may also be materials other than the aluminum-neodymium alloy described above. In other words, the power feed line (scan line) contains a layer including any one of high melting refractory metals such as pure aluminum, aluminum alloy (for example containing 50% or more of aluminum), chromium and molybdenum, or a stacked structure containing at least two layers thereof.

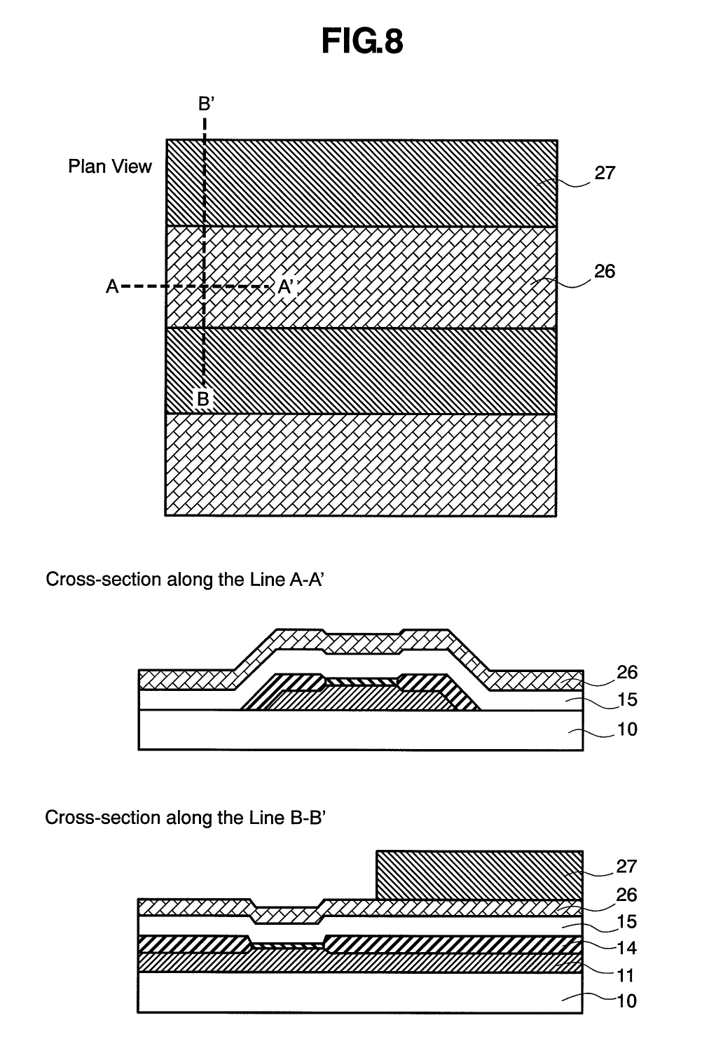

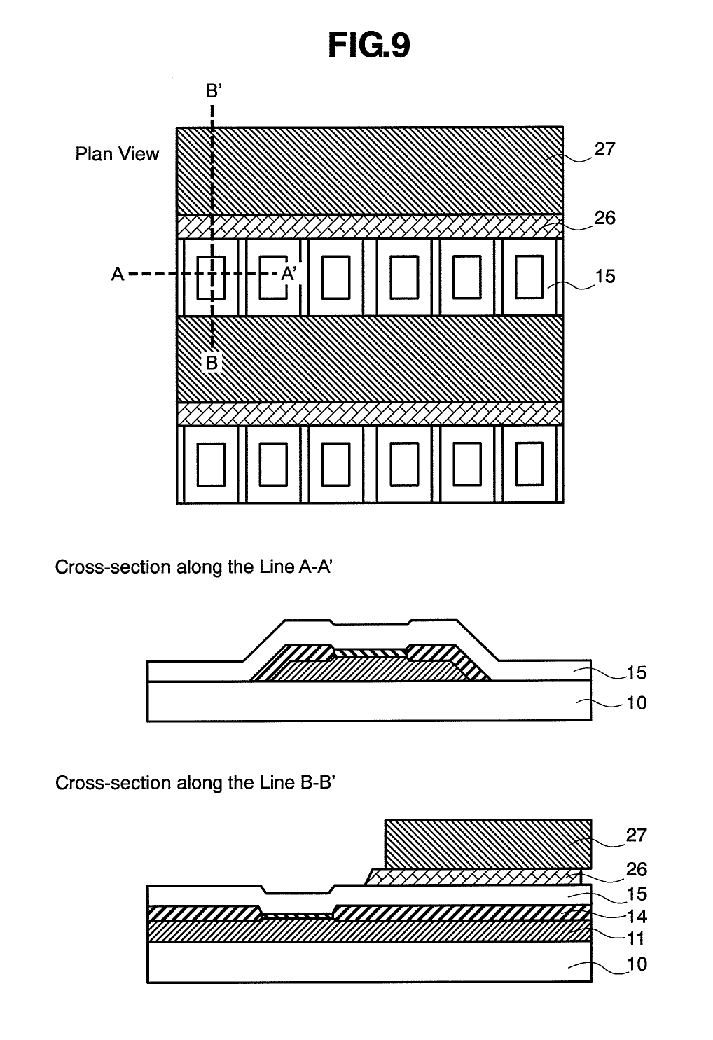

Successively, the upper bus electrode 26 and the second metal film 27 are formed by fabrication so as to be in perpendicular to the lower electrode 11 by a photoetching step. For the etchant of the wet etching, di-ammonium cerium (IV) nitrate, etc. are used in a case of using chromium as an upper bus electrode 26, and an aqueous mixed solution of phosphoric acid, acetic acid, and nitric acid is used for the second metal film 27 in a case of using aluminum-neodymium (Al—Nd) (see FIG. 8, FIG. 9).

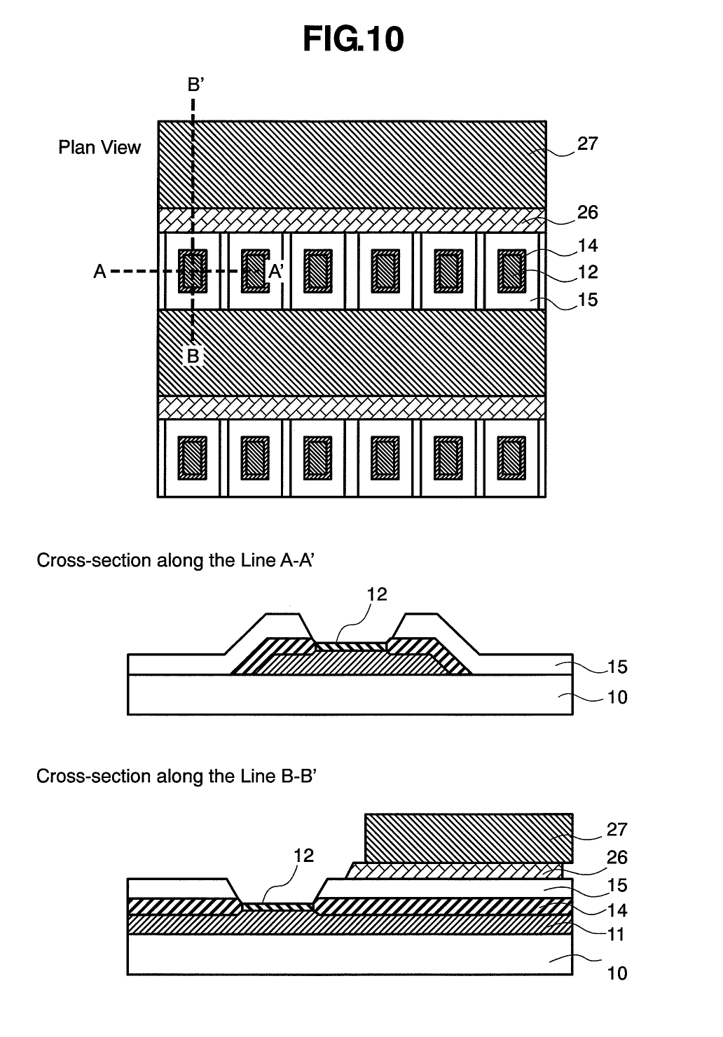

Successively, the interlayer insulating layer 15 including SiN for the opening portion of the scan electrode 21 is fabricated to open the electron emission portion at which the electron acceleration layer 12 is exposed. The electron emission portion is formed to a portion of a crossing of a space put between one lower electrode 11 in the pixel and two scan electrodes in perpendicular to the lower electrode 11. The etching can be conducted, for example, by dry etching using an etchant including CF₄ or SF₆ as a main ingredient (see FIG. 10).

Then, deposition of a conductive thin film 13P for the upper electrode is applied. For the deposition method, sputtering film formation is used for instance. For the conductive thin film 13P, a stacked film, for example, of iridium (Ir), platinum (Pt), and gold (Au) is used, and the film thickness is several nm and, for example, 5 nm. The conductive thin film 13P is isolated in self alignment by the overhang of the second metal film 27 formed by etching back on the side of the scan line adjacent with the upper bus electrode 26 to form an upper electrode 13. The isolated portion is depicted by an arrow C in cross-section along line B-B′ in FIG. 10. The upper electrode 13 is in contact with the chromium film of the upper bus electrode 26 and the Al—Nd film of the second metal film 27 and supplied with power.

The front substrate is stuck by way of the spacer to the back substrate thus manufactured to constitute an image display device (display panel).

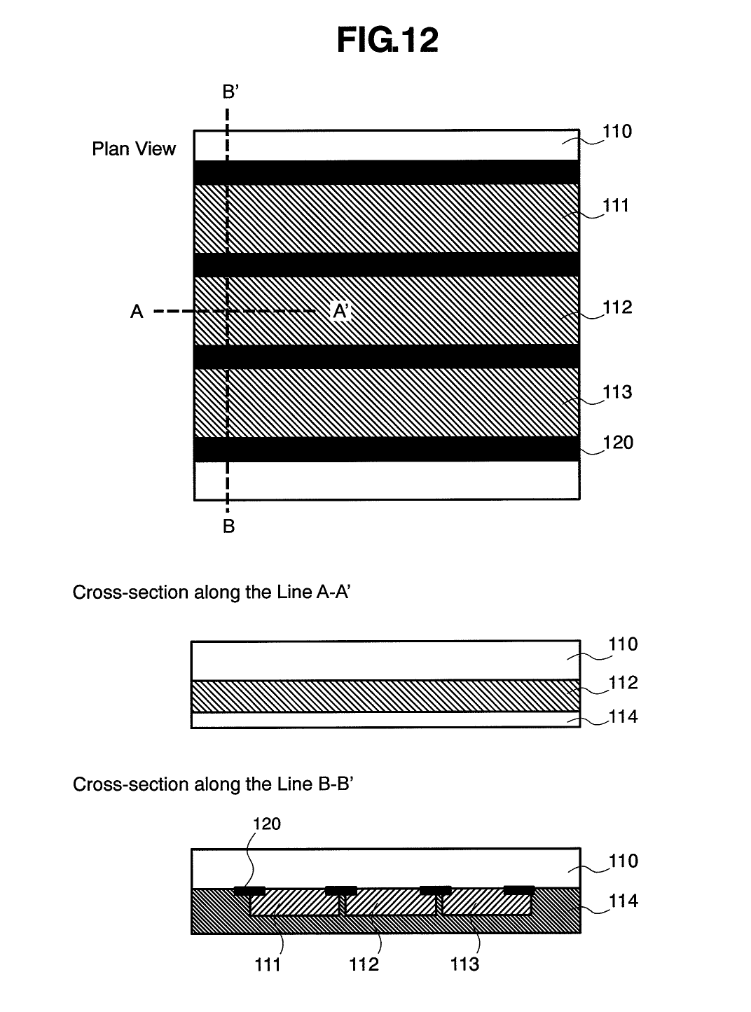

FIG. 12 is a view for explaining the method manufacturing a front substrate. A black matrix 120 for enhancing the contrast of the display images is formed to an insulating substrate 110 (also referred to as front substrate 110) suitably including glass. For the black matrix 120, a solution formed by mixing polyvinyl alcohol (PVA) and sodium dichromate is coated on the insulating substrate 110. Then, UV-rays are irradiated to a portion other than the portions to be left as a matrix by using a mask to apply exposure. PVA in the not-exposed portion is removed, to which a black matrix solution formed by dissolving a graphite powder is coated and dried to form a film. It is formed by lifting off PVA together with the film of the black matrix on the PVA.

Then, phosphors of three colors are formed. At first, an aqueous solution formed by mixing PVA and sodium dichromate with red phosphor particles is coated to the insulating substrate 110, and dried. After irradiating UV-rays to a portion forming the phosphors to apply exposure, the not-exposed region is removed with running water. Thus, the red phosphor 111 is pattern-formed. In the same manner, green phosphors 112 and blue phosphors 113 are formed. In this embodiment, the pattern for the phosphors is in a stripe-shape as shown in FIG. 12. As the phosphors, there can be used, for example, Y₂O₂S:Eu (P22-R) for red, ZnS:Cu, Al (P22-G) for green and ZnS:Ag, Cl (P22-B) for blue can be used.

Then, after filming with a film such as of nitrocellulose, aluminum is vapor deposited entirely to a thickness for example of 75 nm to form a metal back. The metal back acts as an acceleration electrode. Then, the insulating substrate 110 is heated to about 400° C. in atmospheric air to thermally decompose organic materials such as a filming film or PVA. Thus, the front substrate is completed.

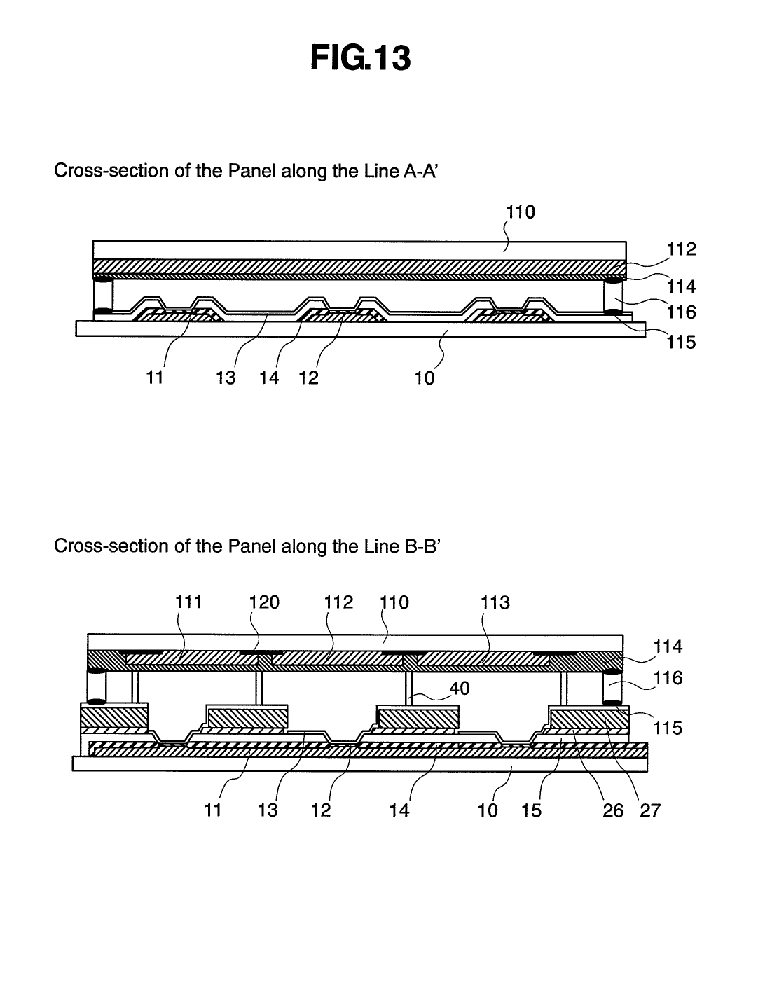

FIG. 13 is an explanatory view for the cross-section along the line A-A′ and the cross-section along the line B-B′ in a state of sticking the back substrate to the front substrate. Spacers 40 are interposed between the front substrate 110 and the back substrate 10, a sealing frame 116 is sealed at the periphery with flit glass 115 to seal completely.

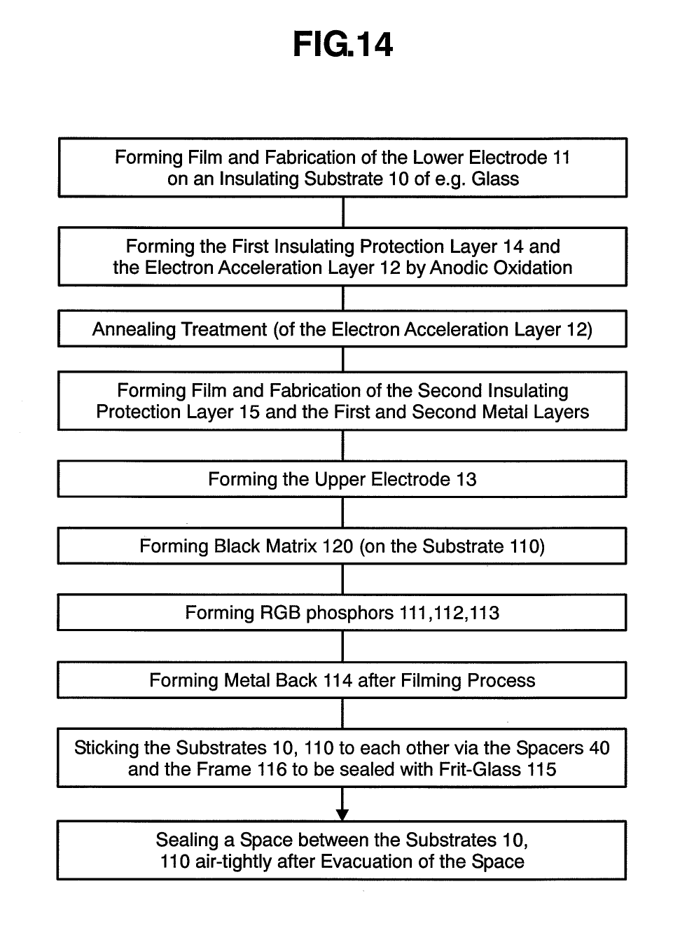

The height of the spacer 40 set such that the distance between the front substrate 110 and the back substrate 10 is about from 1 to 6 mm and, preferably, 2 to 5 mm. In FIG. 13, while the spacers are planted on every scan lines (second metal film 27) for the sake of explanation, the number of the spacers 40 is decreased actually within such a range as capable of enduring the mechanical strength and they are provided, for example, on every about 1 cm. The vacuum degree for the sealed inside is about 10⁻⁷ Torr. The manufacturing steps described above are collectively shown in FIG. 14.

The vacuum degree in the sealed inside is kept by activating the sealed getter material. In a case of an evaporating type getter material including barium (Ba) as a main ingredient, a method of forming a film of the getter material by high frequency induction heating can be adopted. Further, a non-evaporating getter material including zirconium (Zr) as a main ingredient can also be used.

In this embodiment, a distance between the front substrate 110 and the back substrate 10 is set to 2 to 5 mm and the acceleration voltage to be applied to the metal back can be from 4 to 10 kV. Thus, phosphors for use in cathode ray tubes can be used for the phosphors.

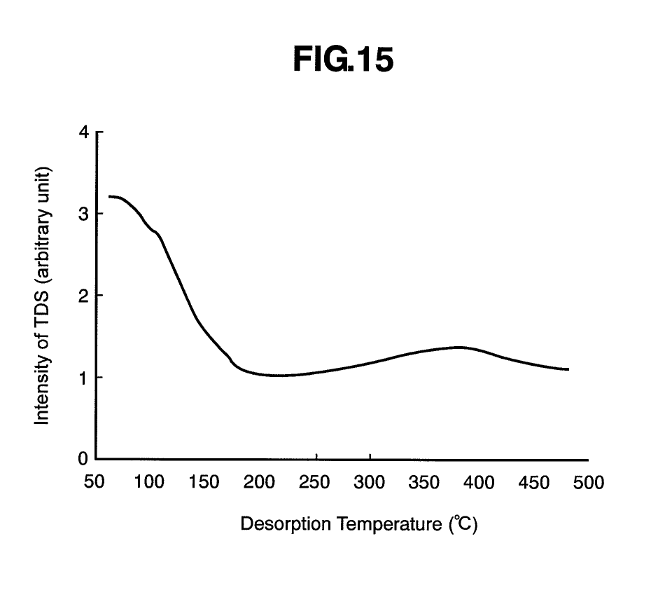

FIG. 15 is a graph for explaining the temperature dependency of the water desorption amount in (the dehydration amount of) the anodic oxide film manufactured in the embodiment of the invention by conducting thermal desorption analysis on the anodic oxide film. The abscissa expresses the temperature and the ordinate expresses the intensity according to TDS analysis (thermal desorption analysis). FIG. 15 shows that a great amount of water contents are desorbed in a range of the heating temperature of from 50° C. to 200° C. and, further, water content is desorbed also at a high temperature of 200° C. or higher.

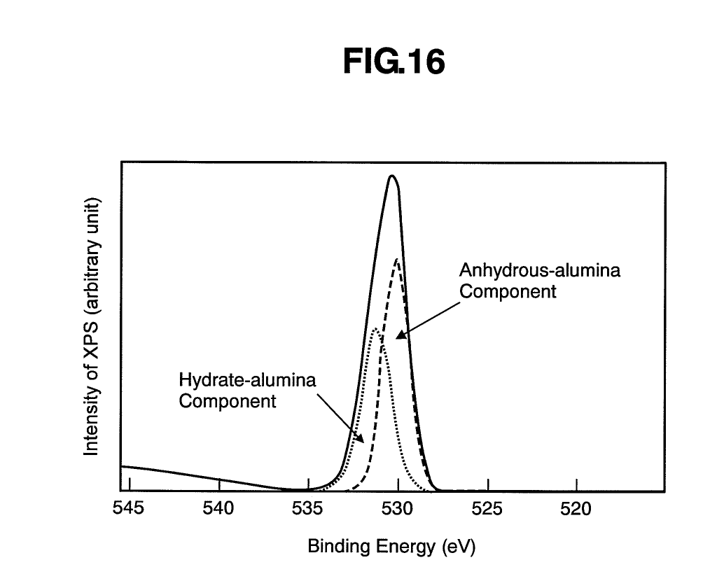

FIG. 16 is a view for explaining an example of the result of XPS analysis (X-ray photoelectron spectroscopy) for quantifying the amount of water contained in the anodized film (anodic oxidation film) of aluminum. The abscissa represents inter-atom binding energy (eV), and the ordinate represents an XPS intensity (arbitrary unit). The XPS intensity (photoelectron measured value) shown on the ordinate shows a peak for normal distribution around the value on the abscissa (binding energy) specified by the electron state of the atom (depending on the bonding state of the atom) in the anodic oxide film of aluminum (Al₂O₃: alumina). In a case where the peak is generated to each of adjacent two binding energies, the peaks are overlapped to form a peak not in regular distribution overriding the two binding energies. In FIG. 16, the annealing temperature was set to 100° C. Evaluation was made on the bonding state around oxygen (O1s peak) for the alumina film just after the anodic oxidation. Alumina includes a hydrate alumina component and anhydrous-alumina component. The XPS intensity of alumina is shown by a solid line, the hydrate-alumina component is shown by a dotted line, and the anhydrous-alumina component is shown by a broken line. In view of the shift of the binding energy by the XPS analysis, the hydrate-alumina component and the anhydrous-alumina component are separated and the integrated intensity ratio is calculated and evaluated. The integrated intensity shows a value corresponding to the area of the peak in the normal distribution.

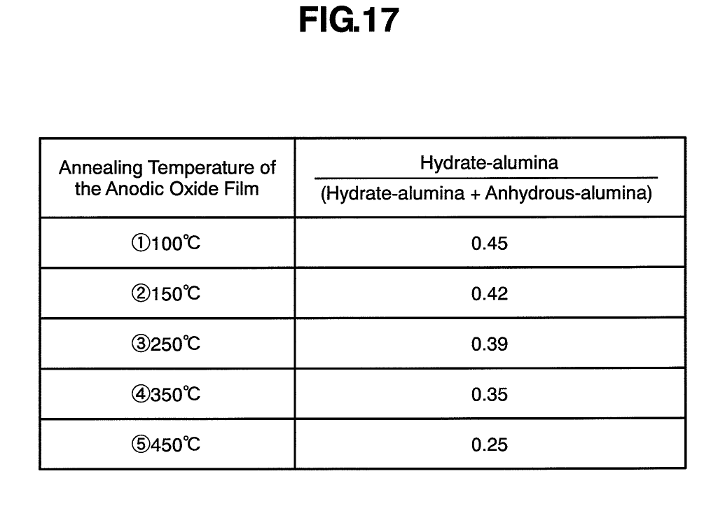

FIG. 17 is a view for explaining the result of calculation for the hydrate-alumina ratio in the alumina film (hydrate-alumina/(hydrate alumina+anhydrous-alumina)) in the alumina film determined by evaluation according to analysis of FIG. 16 on every annealing process conditions (annealing temperature for anodic oxide film). FIG. 17 shows that the hydrate-alumina ratio decreases along with increase of the annealing temperature.

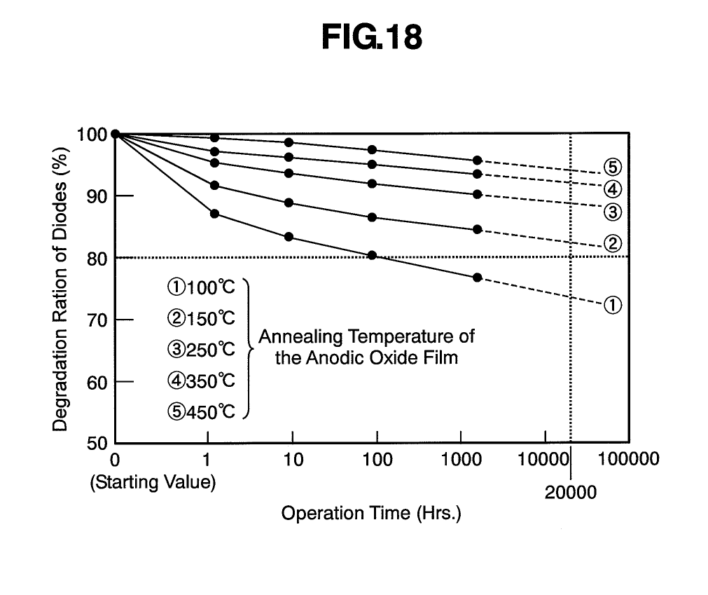

FIG. 18 is a graph showing the result of measurement for degradation characteristics to time of MIM diodes manufactured on every annealing process conditions. Since the current amount of an MIM diode is in proportion with the luminance of the image display device, as the degradation amount (ratio) of the diode characteristic is smaller, better characteristic is shown. Usually, in a case of application to an image display device, it is required that the luminance is kept at a predetermined level or higher even during operation at least for several tens of thousands of hours. As an index of the reliability in this embodiment, it is conveniently defined that the initial diode current is maintained at least for 80% in a case of operating the same or 20,000 hours. Those obtained by the annealing treatment at a temperature of 150° C. or higher or up to 450° C. satisfy the conditions.

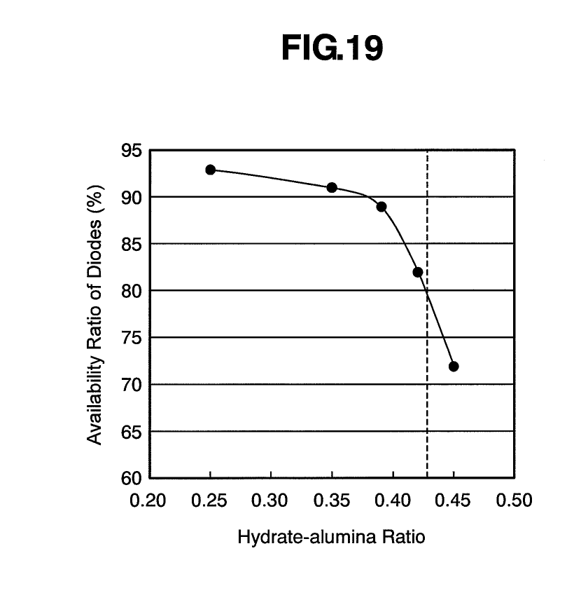

FIG. 19 is a graph showing a correlation between the availability ratio of diode estimated on the basis of the result of FIG. 18 and the hydrate-alumina ratio in the alumina film calculated on the basis of the result of FIG. 17. The availability ratio of diode is represented as: (diode current after operation for arbitrary time)/(initial diode current). For the calculation of the availability ratio of diode in this embodiment, the diode current upon operation for 20,000 hours is used. FIG. 19 shows that the diode availability ratio exceeds 80% at the hydrate-alumina ratio in the alumina film (anodic oxide film) of 0.25 to 0.42 and an image display of high reliability is obtained.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. An image display device comprising:
one substrate having a number of data lines including aluminum formed in parallel with each other on an inner surface, and a number of scan lines crossing above the data lines by way of an interlayer insulating layer relative to the data lines and formed in parallel with each other, and including a thin film electron emitter array including plural electron emission portions disposed in a two-dimensional matrix formed in the vicinity of the crossing portion between the data lines and the scan lines in an image display region, and
the other substrate disposed being opposed to the inner surface of the one substrate and having a fluorescence surface including plural phosphors at the opposing inner surface thereof that emit light upon excitation by electrons emitted from the thin film electron emitter array, wherein
the thin film electron emitter has an electron acceleration layer using the data line as a lower electrode and includes an anodic oxide film formed by anodizing the surface of the data lines, and an upper electrode that is stacked covering the electron accelerator and constitutes an electron emission electrode,
the anodic oxide film constituting the electron acceleration layer has a hydrate-alumina component and an anhydrous-alumina component in the film, and
the ratio of the hydrate-alumina component to the total for the hydrate-alumina component and the anhydrous alumina ingredient is within a range from 0.25 to 0.42.

2. The image display device according to claim 1, wherein
the upper electrode constituting the electron emission electrode of the thin film electron emitter includes a conductive thin film formed so as to cover the entire surface of the image display region at the layer above the scan line, and electrically connected with the scan lines which is electrically separated between adjacent scan lines.

3. The image display device according to claim 1, wherein the thin film electron emitters are placed at the portions nearer to one side in the lateral direction of the scan lines.

4. The image display device according to claim 2, wherein
the thin film electron emitter is constituted above the anodic oxide film constituting the electron acceleration layer placed in the opened portion of the interlayer insulating layer for insulating the data lines and the scan lines with the conductive thin film being as the electron emission electrode.

5. The image display device according to claim 1, wherein
spacers for controlling the distance between the one substrate and the other substrate are placed at portions nearer to the side of the scan lines opposite to the electron emitter portions in the lateral direction thereof.

6. The image display device according to claim 1, wherein
the scan lines includes a stacked structure containing pure aluminum, aluminum alloy, chromium, or at least two layers thereof, and the upper electrode is a single layer of noble metal or two or more stacked layers of the noble metals.

7. The image display device according to claim 6, wherein
the aluminum alloy is an alloy of aluminum and neodymium.

8. The image display device according to claim 6, wherein
the noble metal is one of iridium, platinum and gold.
